(19) United States
(12) Patent Application Publication
(10) Pub. No.: US 2020/0320519 A1
(43) Pub. Date: Oct. 8, 2020

(54) SYSTEMS AND METHODS FOR A DIGITAL WALLET APPLYING USAGE RULES ON CRYPTO CURRENCIES AND OTHER CRYPTO ASSETS

(71) Applicant: KAMELEONO, LTD., Givat Shmuel (IL)

(72) Inventor: Tal ASA, Givat Shmuel (IL)

(73) Assignee: KAMELEONO, LTD., Givat Shmuel (IL)

(21) Appl. No.: 16/901,726

(22) Filed: Jun. 15, 2020

Related U.S. Application Data
(63) Continuation of application No. PCT/IL2019/050038, filed on Jan. 8, 2019.
(60) Provisional application No. 62/615,472, filed on Jan. 10, 2018.

(51) Int. Cl. G06Q 20/36

(52) U.S. Cl. CPC G06Q 20/3678

(57) ABSTRACT

Systems and methods for applying rules on crypto assets, comprising: an admin user crypto wallet; an end user crypto wallet; receiving in the admin wallet an action request from the end user via a smart contract; checking eligibility of the requested action according to the predefined or default rules; and approving and performing the action via a transaction to the block chain or denying the request, according to the eligibility.

### CROSS-REFERENCE TO RELATED APPLICATIONS

This application is a continuation of an International Patent Application No. PCT/IL2019/050038 filed on Jan. 8, 2019, the PCT/IL2019/050038 application claims priority from U.S. Provisional No. U.S. 62/615,472, filed Jan. 10, 2018, the contents of which are hereby incorporated by reference.

### TECHNICAL FIELD

Embodiments of the present disclosure relate generally to systems and methods for a digital wallet applying usage rules on crypto currencies and other crypto assets.

### BACKGROUND

### Description of Related Art

In a block chain-based implementation, currencies and other assets are attached to a specific crypto wallet address. The holder of the private key which is associated with that wallet address is considered to be the owner of the wallet and has full control over the currencies and assets it holds.

Although the block chain technology presents a highly-secured way to store and transfer value on a trustless network, it lacks when it comes to safety, e.g. recovering lost coins or protecting against unwanted large transfer of funds, which cannot be refunded.

Unlike the old world, in which money was held and controlled by central banks, against which you can make claims through high courts or through the regulatory body, holding crypto currencies that are de-centralized, meaning that there is no central authority supervising, implies the risk, therefore, of loss of access to the currencies, meaning the loss of the coins.

The current available solutions to those problems are far from being practical for the majority of users.

Current Solution #1: Multi-Sig Wallet

A multi-sig wallet is a wallet that needs multiple signatures in order to accept a transaction. A multi-sig Wallet is supported by most block chain implementations.

It can be defined for example, that two signatures out of three are needed in order to access and control the funds in a multi-sig wallet. This approach is very limited and problematic because the signatures can be used anytime and have full control over the funds once approved. Moreover, the multi-sig wallet does not protect against unwanted large funds transfers.

Current Solution #2: Paper Wallet

Paper wallet is a physical copy of the wallet seed. The idea is to keep it in a safe place and use it when the crypto wallet is lost or ruined to get access to the funds. This solution is suitable only for the recovering lost funds problem. It is also problematic because a paper wallet can be stolen. Therefore, a physical safe is needed in order to keep the paper wallet, and the access to that safe needs to be secured.

Current Solution #3: Smart Contract

A smart contract, also known as a crypto-contract, is a computer program that directly controls the transfer of digital currencies or assets between parties under certain conditions. Theoretically, a crypto wallet owner can write and deploy a smart contract that will hold funds and apply rules on the usage and access to the funds it holds. Practically, for programming such a contract, a professional programmer is needed. Even interaction with a smart contract as a user is too complex to handle by a non-programmer Moreover, bugs in a smart contract might result in loss of all the funds it holds. Only a generic smart contract that has been properly audited by peer review, used by many users over a long period of time, and has a frontend app to interact with, can be safe and practical to use.

Hence, improved systems and methods, as described in this application, are still a long-felt need.

### SUMMARY

According to an aspect of the disclosed embodiments a computer implemented method for applying rule on crypto asset, the method comprising: providing a platform having a non-transitory computer-readable medium storing processor executable instructions on a computing device allowing an admin user to manage a crypto wallet and: predefine rules regarding said crypto asset possible actions; register services; and add funds, in said platform, having a non-transitory computer-readable medium storing processor executable instructions on a computing device allowing an end user to manage a crypto wallet and: request an action to be performed, wherein said action has said predefined rule or a default rule, receiving in said admin wallet an action request from said end user via a smart contract; checking eligibility of said requested action according to said predefined or default rules; approving and performing said action via a transaction to said block chain or denying said request, according to said eligibility.

It is further within provision of the disclosure to be wherein said admin user instructions and end user instructions are executable on a single computing device.

It is further within provision of the disclosure to further comprise: allowing said end user to store crypto asset in a smart contract on said block chain; define at least one backup wallet using said smart contract on said block chain, wherein said crypto asset is locked for a predefined period of time and further wherein said predefined period of time is calculated from the last action performed via said end user wallet; and transfer, when eligible, said crypto assert from said smart contract to said backup wallet.

It is further within provision of the disclosure to further comprise: allowing said admin user to define maximum threshold of crypto asset to be transferred from said end user wallet without further approval using a smart contract; receive an action request from said end user for a transaction; checking said request's eligibility; and denying said actions request or requesting further approval for action exceeding said threshold.

It is further within provision of the disclosure to further comprise: allowing said admin user to define maximum threshold of crypto asset to be transferred from said end user wallet in each defined period to time using a smart contract; receive an action request from said end user for a transaction; checking said request's eligibility; and denying said actions request for action exceeding said threshold.

These, additional, and/or other aspects and/or advantages of the present disclosure are set forth in the detailed description which follows, possibly inferable from the detailed description, and/or learnable by practice of the present disclosure.

### BRIEF DESCRIPTION OF THE FIGURES

In order to understand the present disclosure and to see how it may be implemented in practice, a plurality of embodiments will now be described, by way of non-limiting example only, with reference to the accompanying drawings, in which:

FIG. 1 illustrates a generic architecture of an embodiment of the present disclosure;

FIG. 2 illustrates a minimal wallet as in an embodiment of the present disclosure;

FIGS. 3 & 4 illustrate a flow chart of a method for recovering lost coins as in an embodiment of the present disclosure;

FIGS. 5 & 6 illustrate a flow chart of a method for large transfer protection as in an embodiment of the present disclosure; and

FIGS. 7 & 8 illustrate a flow chart of a method for “robbery” protection as in an embodiment of the present disclosure.

### DETAILED DESCRIPTION OF THE FIGURES

The following description is provided, alongside all chapters of the present disclosure, so as to enable any person skilled in the art to make use of the present disclosure and sets forth the best modes contemplated by the inventor of carrying out the present disclosure. Various modifications, however, will remain apparent to those skilled in the art, since the generic principles of the present disclosure have been defined specifically to provide a means and method for a digital wallet applying usage rules on crypto currencies and other crypto assets.

In the following detailed description, numerous specific details are set forth in order to provide a thorough understanding of embodiments of the present disclosure. However, those skilled in the art will understand that such embodiments may be practiced without these specific details. Just as each feature recalls the entirety, so may it yield the remainder. And, ultimately, when the features manifest, so an entirely new feature may be recalled. Reference throughout this specification to “one embodiment” or “an embodiment” means that a particular feature, structure, or characteristic described in connection with the embodiment is included in at least one embodiment of the present disclosure.

The phrases “at least one”, “one or more”, and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

The term ‘plurality’ refers hereinafter to any positive integer (e.g., 1,5, or 10).

The present disclosure relates to systems and methods for allowing an enhanced use of block chain technology by separating the roles of a single user to an admin user and end user in order to try and achieve safe and sophisticated use.

Generally speaking, the system and method may allow a computer-implemented method for applying one or more rules on crypto asset, the method comprising a computing device, such as a smartphone or computer, allowing an admin user to manage a crypto wallet and predefine rules regarding crypto assets, such as crypto currencies, to register services (smart contracts) to the block chain, and to add assets and funds to the services as well as providing an end user with the ability to request an action to be performed on the block chain. The method and system may further allow receiving, in the admin wallet, action requests from the end user, and allow the smart contract to check the eligibility of the request and approve and perform it, if it is, indeed, eligible.

The system and method may comprise two kinds of software. The first may be a local crypto wallet that resides on the end user personal computing device, such as a smart phone or computer, while the second may be a distributed application that resides as a block chain implementation, in the form of smart contracts.

The system and method may comprise three types of components: an admin crypto wallet, a user crypto wallet, and a smart contract. The admin crypto wallet may be responsible for configuring the smart wallet's behavior by setting rules. The smart contract may be responsible for enforcing those rules and holding the funds. The user crypto wallet may be responsible for requesting standard crypto wallet actions, such as transferring funds.

In some embodiments of the present disclosure, external smart contracts, crypto wallets, or smart wallets may also be considered as user crypto wallets. The admin crypto wallet may also be set to act as a user crypto wallet in an embodiment of the present disclosure.

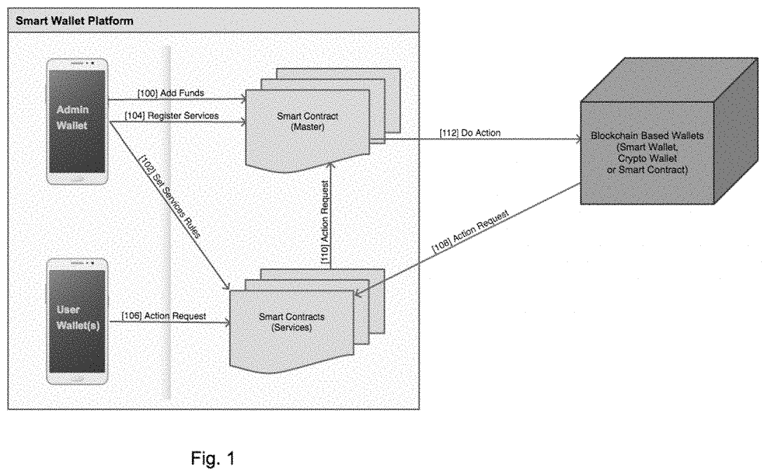

FIG. 1 depicts a block diagram illustrating a generic architecture of the system's wallet. The possible actions in a smart wallet platform can be divided into two types: configuration and usage.

Configuration: 100 The admin crypto wallet may add funds to the main smart contract. 102 The admin crypto wallet may set the rules for the services smart contracts. 104 The admin crypto wallet may register the services smart contracts on the main smart contract.

Usage: 106 the user crypto wallet may send a message to a service smart contract to request the transfer of funds to an external smart wallet, crypto wallet, or smart contract. 108 External smart wallets, crypto wallets, or smart contracts may send a request to the service smart contract to receive funds. 110 When a request to transfer or receive funds is approved, the service smart contract may send a request to the main smart contract to execute the request. 112 When a request to transfer or receive funds originates from a registered service smart contract and it is within the defined limitations set for these services, the main smart contract may execute the request.

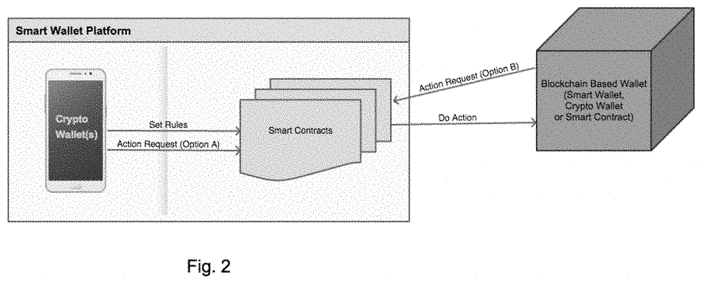

FIG. 2 is a block diagram illustrating a minimal implementation of the smart wallet platform in which the crypto wallet may act both as an admin crypto wallet and as a user crypto wallet. Furthermore, in such implementations, the smart contract may act both as a master smart contract and as a services smart contract.

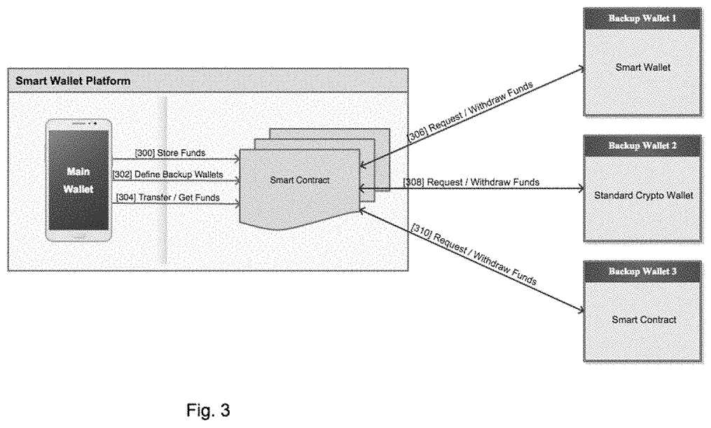

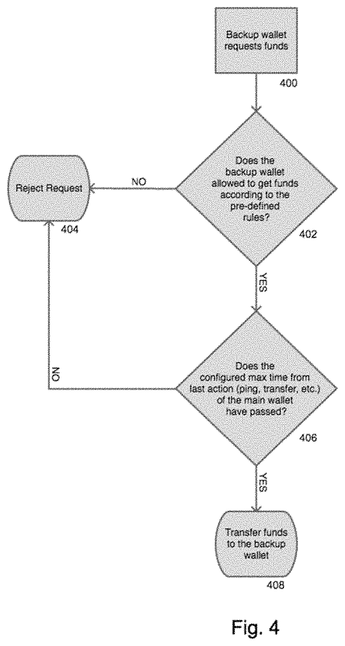

FIG. 3 is a block diagram of a specific embodiment of the present disclosure, in which the smart wallet platform may be used to secure and recover lost funds in case the main crypto wallet private key is lost or cannot be recovered. 300 The main crypto wallet stores funds to be protected in the smart contract. 302 The main crypto wallet defines backup wallets and can set inactive time periods. 304 The main crypto wallet acts as a standard crypto wallet, sending and receiving funds. 306 308 310 If the time period has passed without any activity from the main crypto wallet, the backup wallets may be able to withdraw the stored funds according to the rules that were pre-defined by the main wallet. The wallet can be another smart wallet, a standard crypto wallet, or a smart contract.

The lost funds protection, as in an embodiment of the present disclosure, may be used also to perform a personal trust service by setting rules which allow each backup wallet to withdraw only a limited amount or a percent of the stored funds (in general or regarding a certain duration of time).

FIG. 4 is a flow chart of a specific embodiment of the present disclosure, in which the smart wallet platform is used to recover lost funds in case the main crypto wallet private key is lost or cannot be recovered. 400 The backup wallet may request withdrawal of funds from the smart wallet platform by sending the request to the smart wallet's smart contract. 402 The smart contract may check if the requesting backup wallet is allowed to withdraw funds (in general or under predefined rules). 404 If the answer is negative, the request of the backup wallet may be rejected. 406 If the answer is positive, the smart contract may check if the pre-defined time period has passed since last activity of the main crypto wallet. 404 If the answer is negative, the request of the backup wallet may be rejected. 408 If the answer is positive, the funds request may be sent from the smart contract to the backup wallet.

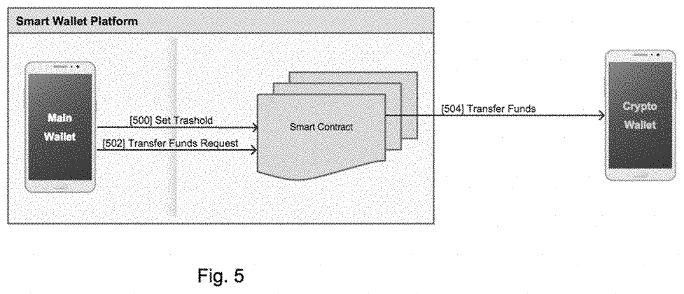

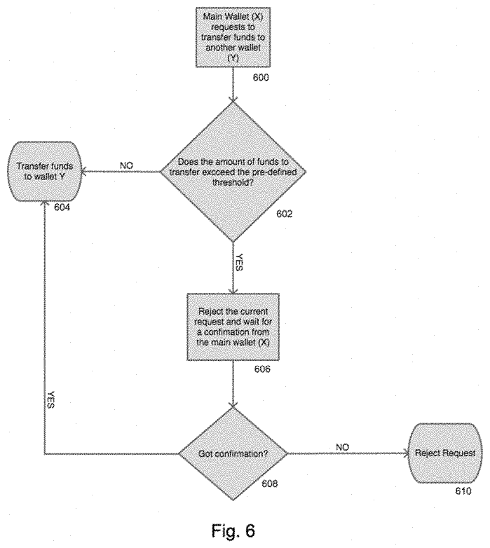

FIG. 5 is a block diagram of a specific embodiment of the present disclosure, in which the smart wallet platform may be used to protect against unwanted transfer of a large sum of funds. 500 The main wallet may set a threshold for the amount of funds that may be transferred in a single transfer request. 502 The main wallet requests a funds transfer to an external crypto wallet. 503 The smart contract may ensure that the threshold is not exceeded and may request for further confirmation, or it may reject the request if the threshold is exceeded.

FIG. 6 is a flow chart of a specific embodiment of the present disclosure, in which the smart wallet platform may be used to protect against unwanted transferring of large sums of funds. 600 The main wallet may request to transfer funds to an external wallet. 602 The smart contract may check whether the funds amount exceeds the predefined threshold. 604 If the answer is negative, the funds may be immediately transferred to the external wallet. 606 If the answer is positive, the smart wallet may reject the current request and wait for a confirmation from the main wallet. 608 The smart contract may check if the next request from the main wallet is a confirmation to allow the rejected transfer request. 604 If the answer is positive, the funds may be immediately transferred to the external wallet. 610 If the answer is negative, the request may be rejected.

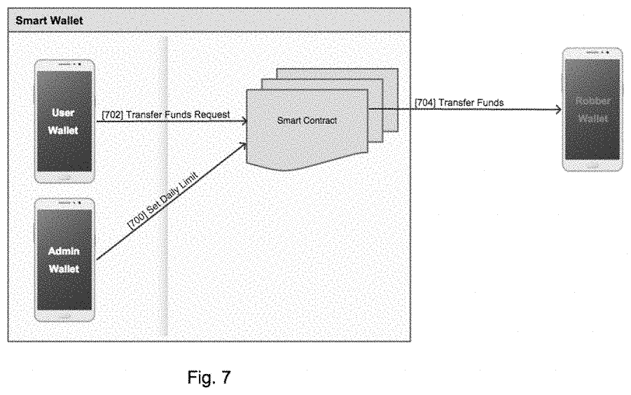

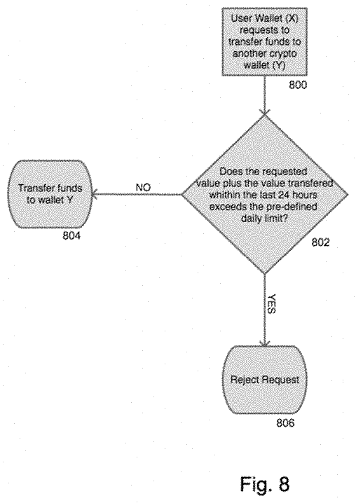

FIG. 7 is a block diagram of a specific embodiment of the present disclosure, in which the smart wallet platform may be used to protect against robbery by physically forcing the victim to transfer funds to the robber's crypto wallet. 700 The admin wallet may set a daily limit of funds that may be transferred. 702 The user wallet may be used to request transfer funds from the smart contract. 704 The smart contract may execute the transfer only if the daily limit is not exceeded. In some embodiments of the present disclosure, the user wallet may not change these settings or bypass them. If the admin wallet is kept in a safe place and it is not at reach during a robbery situation, the victim may change the daily limit. Furthermore, the victim's wallet application may show only the daily limit as available funds, hiding the actual funds stored in the smart wallet.

In further embodiments of the present disclosure, the admin user may predefine a time-lock period for changing the rules and releasing funds.

FIG. 8 is a flow chart of a specific embodiment of the present disclosure, in which the smart wallet platform may be used to protect against robbery by physically forcing the victim to transfer funds to the robber's crypto wallet. 800 The user wallet may send a request to the smart contract to transfer funds to an external crypto wallet. 802 The smart contract may check whether this transfer will exceed the daily limit. 804 If the answer is negative, the funds may be transferred to the external crypto wallet. 806 If the answer is positive, the request may be rejected.

In some embodiments of the present disclosure, the system and method may be implemented on an existing blockchain, such as Ethereum, without requiring new dedicated block chain implementations.

Although selected embodiments of the present disclosure have been shown and described, it is to be understood that the present disclosure is not limited to the described embodiments. Instead, it is to be appreciated that changes may be made to these embodiments without departing from the principles and spirit of the present disclosure, the scope of which is defined by the claims and the equivalents thereof.

What is claimed is:

1. A computer implemented method for applying at least one rule on crypto assets, the method comprising:
providing a platform having a non-transitory computer-readable medium storing processor executable instructions on a computing device allowing an admin user to manage a crypto wallet and:
predefine rules regarding the crypto asset possible actions;
register services; and
add funds,
in the platform, having a non-transitory computer-readable medium storing processor executable instructions on a computing device allowing an end user to manage a crypto wallet and:
request an action to be performed, wherein the action has the predefined rule or a default rule;
receiving in the admin wallet an action request from the end user via a smart contract;
checking eligibility of the requested action according to the predefined or default rules; and
approving and performing the action via a transaction to the block chain or denying the request, according to the eligibility.

2. The method of claim 1 wherein the admin user instructions and end user instructions are executable on a single computing device.

3. The method of claim 1 further comprising:
allowing the end user to store crypto assets in a smart contract on the block chain;
defining at least one backup wallet using the smart contract on the block chain, wherein the crypto asset is locked for a predefined period of time and further wherein the predefined period of time is calculated from the last action performed via the end user wallet; and
transferring, when eligible, the crypto asset from the smart contract to the backup wallet.

4. The method of claim 1 further comprising:
allowing the admin user to define a maximum threshold of crypto asset to be transferred from the end user wallet without further approval using a smart contract;
receiving an action request from the end user for a transaction;
checking the request's eligibility; and
denying the actions request or requesting further approval for action exceeding the threshold.

5. The method of claim 1 further comprising:
allowing the admin user to define a maximum threshold of crypto asset to be transferred from the end user wallet in each defined period of time using a smart contract;
receiving an action request from the end user for a transaction;
checking the request's eligibility; and
denying the actions request for action exceeding the threshold.

6. A system for applying at least one rule on crypto assets, comprising:
a processing circuitry; and
a memory, the memory containing instructions which, when executed by the processing circuitry, configure the system to:
provide a platform having a non-transitory computer-readable medium storing processor executable instructions on a computing device allowing an admin user to manage a crypto wallet and:
predefine rules regarding the crypto asset possible actions;
register services; and
add funds,
in the platform, having a non-transitory computer-readable medium storing processor executable instructions on a computing device allowing an end user to manage a crypto wallet and:
request an action to be performed, wherein the action has the predefined rule or a default rule;
receive in the admin wallet an action request from the end user via a smart contract;
check eligibility of the requested action according to the predefined or default rules; and
approve and perform the action via a transaction to the block chain or denying the request, according to the eligibility.

7. The system of claim 6 wherein the admin user instructions and end user instructions are executable on a single computing device.

8. The system of claim 6, wherein the system is further configured to:
allow the end user to store crypto assets in a smart contract on the block chain;
define at least one backup wallet using the smart contract on the block chain, wherein the crypto asset is locked for a predefined period of time and further wherein the predefined period of time is calculated from the last action performed via the end user wallet; and
transfer, when eligible, the crypto asset from the smart contract to the backup wallet.

9. The system of claim 6, wherein the system is further configured to:
allow the admin user to define a maximum threshold of crypto asset to be transferred from the end user wallet without further approval using a smart contract;
receive an action request from the end user for a transaction;
check the request's eligibility; and
deny the actions request or request further approval for action exceeding the threshold.

10. The system of claim 6, wherein the system is further configured to:
allow the admin user to define a maximum threshold of crypto asset to be transferred from the end user wallet in each defined period of time using a smart contract;
receive an action request from the end user for a transaction;
check the request's eligibility; and
deny the actions request for action exceeding the threshold.
